(19) United States
(12) Patent Application Publication
(10) Pub. No.: US 2022/0245611 A1
(43) Pub. Date: Aug. 4, 2022

(54) GIFTING SYSTEM AND METHOD

(71) Applicant: Abbasali Kermali, Richmond Hill (CA)

(72) Inventor: Abbasali Kermali, Richmond Hill (CA)

(21) Appl. No.: 17/649,435

(22) Filed: Jan. 31, 2022

Related U.S. Application Data
(60) Provisional application No. 63/144,706, filed on Feb. 2, 2021.

(51) Int. Cl. G06Q 20/32

(52) U.S. Cl. CPC G06Q 20/322

(57) ABSTRACT

A gifting system and method is disclosed herein. The system is configured to connect “gifting users” (persons giving a gift) with “vendor users” (businesses that offer goods and services that can be given as gifts) to purchase one or more gifts for a “recipient user” (persons receiving the gift). The gifting system preferably facilitates efficient gift giving to and from anywhere in the world.

### CROSS-REFERENCE TO RELATED APPLICATION

The present application is related to and claims priority to U.S. Provisional Patent Application No. 63/144,706 filed Feb. 2, 2021, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of electronic commerce of existing art and more specifically relates to electronic commerce used specifically for gifting.

### RELATED ART

A gift is something given to someone without the expectation of anything in return. A gift may be a physical item, such as flowers, food items, gift cards, etc.; or an activity such as spa services, dining experience, a concert, etc. Gifts are given all over the world for many reasons. For example, gifts may be given for a special occasion, for sustaining social relations, for congratulating a friend or family member, etc.

The act of gift giving is important in society. However, gift giving can be a daunting task as devising a new, unique and creative gift typically gets more difficult with each gift. In addition to this, the task is especially daunting if the recipient is not well known to the gift-giver, or if the recipient does not live locally to the gift-giver. For example, the recipient may have an allergy or intolerance that the gift-giver does not know of, or the gift-giver may not know any local businesses to the recipient and may struggle getting items delivered to the recipient due to lack of knowledge of the local area, language barriers, etc. Thus, a suitable solution is desired.

### SUMMARY OF THE INVENTION

In view of the foregoing disadvantages inherent in the known electronic commerce art, the present disclosure provides a novel gifting system and method. The general purpose of the present disclosure, which will be described subsequently in greater detail, is to provide a system and method configured to facilitate gift giving to and from anywhere in the world.

A computer implemented method for gift giving is disclosed herein. The computer implemented method may include the steps of: receiving, at a server, a gift request from a gifting user; retrieving, via the server, gift information stored on at least one database on the server, the gift information including a plurality of potential gifts provided by a plurality of vendor users; displaying the gift information to the gifting user; receiving, at the server, at least one selection of at least one gift from the gifting user; displaying a data input form to the gifting user; receiving, at the server, recipient information from at least one of the gifting user and at least one recipient user, the recipient information including at least recipient preference information; generating, via the server, an at least one order request, the at least one order request including the at least one gift and the recipient information; sending, via the server, the at least one order request to at least one chosen vendor user, the at least one chosen vendor user being associated with the at least one gift; and selectively displaying the at least one order request to the at least one chosen vendor user.

According to another embodiment, a system for gift giving is also disclosed herein. The system may include at least one server including at least one database and at least one processor. The at least one server may store computer executable instructions that when executed cause the at least one processor to: receive a gift request from a gifting user; retrieve gift information stored on the at least one database on the server, the gift information including a plurality of potential gifts provided by a plurality of vendor users; display the gift information to the gifting user; receive at least one selection of at least one gift from the gifting user; display a data input form to the gifting user; receive recipient information from at least one of the gifting user and at least one recipient user, the recipient information including at least recipient preference information; generate at least one order request, the at least one order request including the at least one gift and the recipient information; send the at least one order request to at least one chosen vendor user, the at least one chosen vendor user being associated with the at least one gift; and selectively display the at least one order request to the at least one chosen vendor user.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a gifting system and method, constructed and operative according to the teachings of the present disclosure.

FIG. 1 is a schematic diagram of a system for gift giving illustrating a gifting user and a plurality of vendor users, according to an embodiment of the disclosure.

FIG. 2 is a schematic diagram of the system for gift giving illustrating the gifting user, at least one chosen vendor user, and a recipient user, according to an embodiment of the disclosure.

FIG. 3 is a schematic diagram of the system for gift giving illustrating at least one server having at least one processor and at least one database, according to an embodiment of the disclosure.

FIG. 4 is a flow diagram illustrating a computer implemented method for gift giving, according to an embodiment of the present disclosure.

FIG. 5 is a flow diagram illustrating the computer implemented method for gift giving, according to an embodiment of the present disclosure.

FIG. 6 is a flow diagram illustrating the computer implemented method for gift giving, according to an embodiment of the present disclosure.

FIG. 7 is a flow diagram illustrating the computer implemented method for gift giving, according to an embodiment of the present disclosure.

FIG. 8 is a front view of a software application on an electronic device of the gifting user, according to an embodiment of the present disclosure.

FIG. 9 is a front view of a data input form on the software application on the electronic device of the gifting user, according to an embodiment of the present disclosure.

FIG. 10 is a front view of an information input request on an electronic device of the recipient user, according to an embodiment of the present disclosure.

FIG. 11 is a front view of an order request on an electronic device of the at least one chosen vendor user, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to electronic commerce and more particularly to a gift giving method and system for facilitating gift giving to and from anywhere in the world. Generally, the system may connect users with vendors to create a unique gift for a third party. Many different vendors offering various goods and services may be contemplated. For example, the vendors may include bakeries, patisseries, gift card providers, florists, party supply providers, etc.

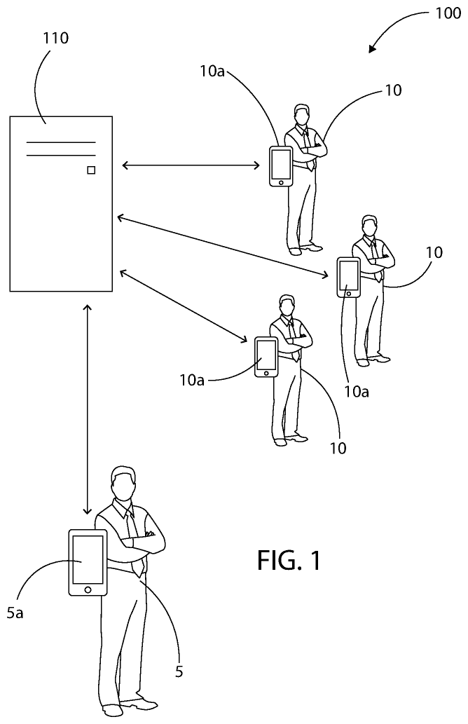

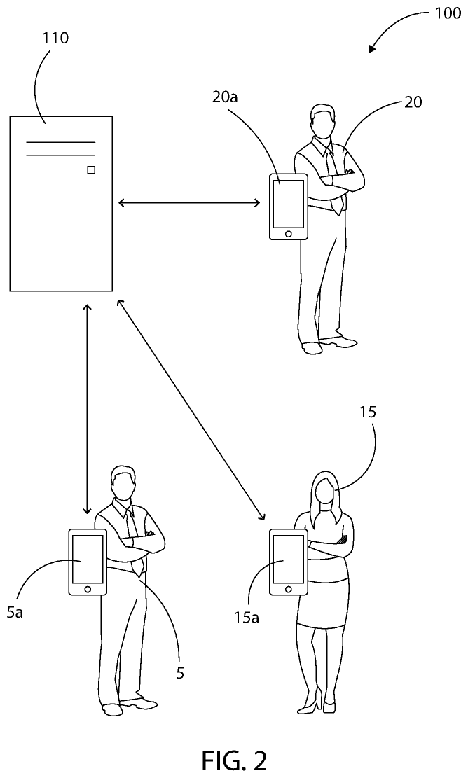

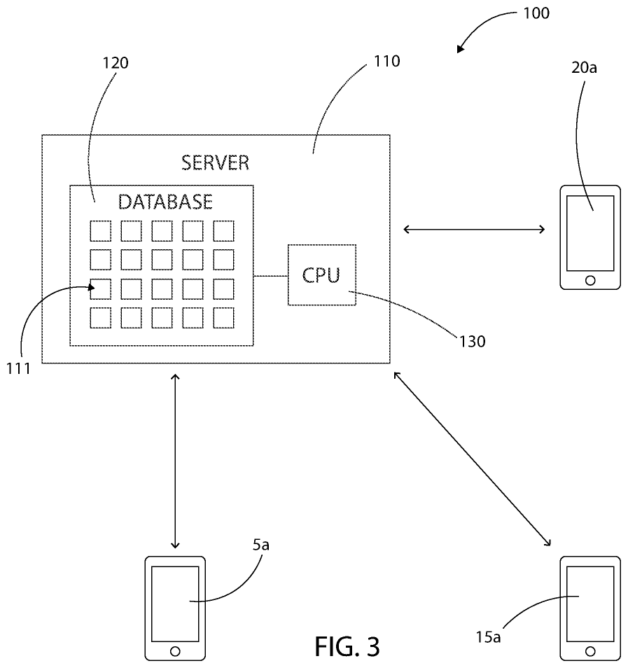

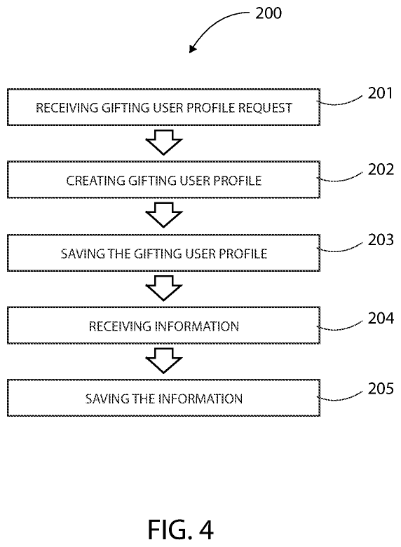

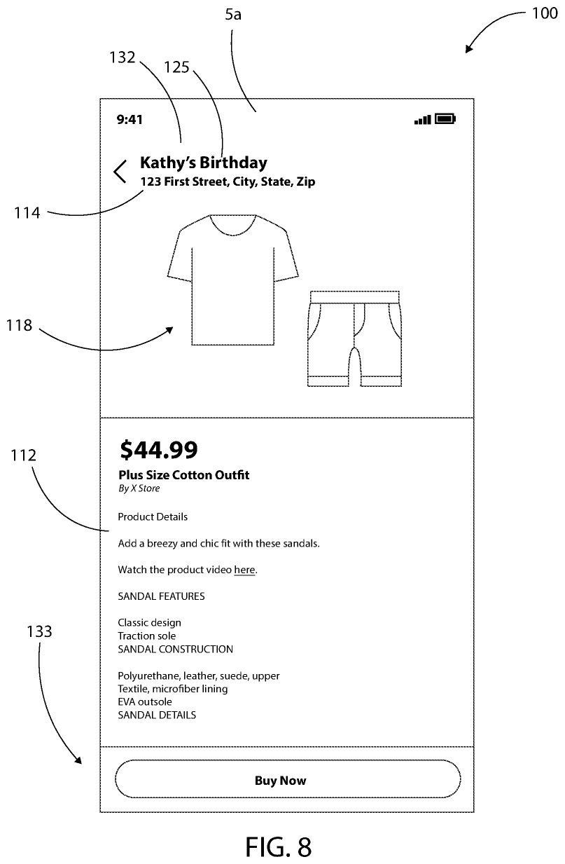

Referring now more specifically to the drawings by numerals of reference, there is shown in FIGS. 1-3 various schematic diagrams illustrating a system 100 for gift giving; in FIGS. 4-7 various flow diagrams illustrating a computer implemented method 200; and in FIGS. 8-11, various views of a software application on a smartphone, according to an embodiment of the present disclosure. The system 100 and method 200 may connect “gifting users” (persons giving a gift) with “vendor users” (businesses that offer goods and services that can be given as gifts) who then delivers the gift to a “recipient user” (persons receiving the gift). It should be appreciated that the terms “gifting user,” “vendor user” and “recipient user” are used in the present disclosure to aid in understanding and are not meant to limit the present disclosure, nor limit users to a particular use of the system 100. For example, a “gifting user” may also be a “recipient user” and vice versa.

A computer implemented method 200 for gift giving may be disclosed herein according to an embodiment of the present disclosure. The computer implemented method 200 may be implemented by the system 100. Particularly, as shown in FIGS. 1-3, the system 100 may include at least one server 110 having at least one database 120 and at least one processor 130. The server 110 may include computer executable instructions 111 causing the processor 130 to perform the computer implemented method 200(s) when executed. The system 100 and method 200 may allow a gifting user 5 to gift a at least one recipient user 15 with goods and/or services offered by at least one vendor user 10. In some embodiments, the system 100 may provide a software application, such as a desktop application, a website, and/or a smartphone application which the user(s) 5, 10, 15, 20 may access via an electronic device, such as a smartphone, tablet computer, desktop computer, laptop computer, smartwatch, or the like.

Preferably, gifting users 5, vendor users 10 and recipient users 15, may create profiles on the system 100. As such, the system 100 may be configured to receive a profile request; create a profile; save the profile to the at least one database 120; receive information pertaining to a user; and save the information to the at least one database 120. For example, as shown in FIG. 4, the computer implemented method 200 may include step 201, receiving, at the server 110 a gifting user profile request from the gifting user 5; step 202, creating, via the server 110 a gifting user profile; step 203, saving, via the server 110 the gifting user profile on the at least one database 120; step 204, receiving, at the server 110 at least one of the recipient information 114, gifting user information and payment information; and step 205, saving, via the server 110, the at least one of the recipient information 114, the gifting user information and the payment information to the gifting user profile on the at least one database 120.

Gifting user information may include information such as name, birthdate, address, etc. of the gifting user 5. Gifting user information may also include dietary restrictions, preferences, allergies, etc. of the gifting user 5. In some embodiments, this may allow the gifting user 5 to share their information if another gifting user 5 wishes to purchase a gift for them. The payment information may include credit card information, debit card information, gift card information, and/or other payment account information.

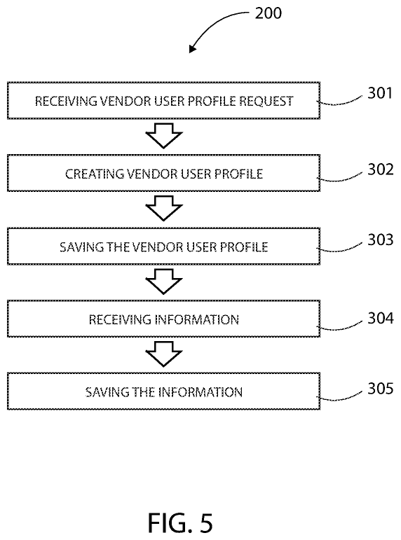

Further, as shown in FIG. 5, the computer implemented method 200 may further include step 301, receiving, at the server 110 a vendor user profile request from the vendor user 10; step 302, creating, via the server 110 a vendor user profile; step 303, saving, via the server 110 the vendor user profile on the at least one database 120; step 304, receiving, at the server 110 a portion of gift information 112, the portion of the gift information 112 including at least one potential gift offered by the vendor user 10; and step 305, saving, via the server 110, the portion of the gift information 112 to the vendor user profile on the at least one database 120. For example, vendor users may input information pertaining to goods/services they offer, images of the goods/services, reviews, information regarding their business, location, etc.

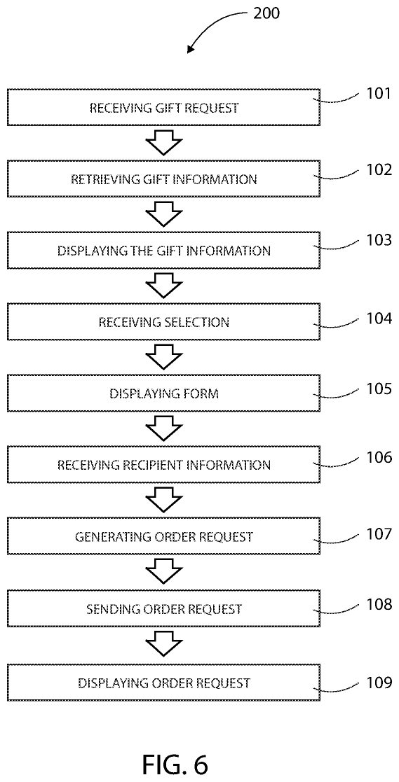

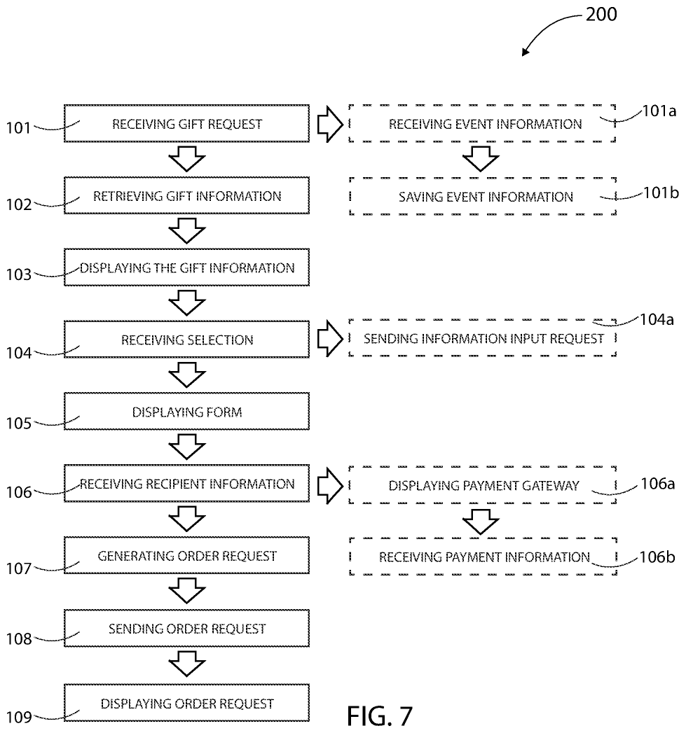

As shown in FIGS. 6-7, in some embodiments, the computer implemented method 200 may begin at step 101: receiving, at a server 110 a gift request from a gifting user 5. The gift request may be manually input into the system 100 by the gifting user 5 via their electronic device 5a. In some embodiments, the gift request may include gift criteria information 125. For example, the gift criteria information 125 may relate to a gift type, an event type (such as birthday, holiday, wedding, etc.); event date, an event theme, location information (for example, location of the at least one recipient user 15, location of event, and the like).

In some embodiments, the computer implemented method 200 may include the step 101a of receiving, at the server 110, event information 132 from the gifting user 5; and in some embodiments, step 101b of saving, via the server 110, the event information 132 to the gifting user profile. For example, the system 100 may store an event and an event date. Further, the system 100 may selectively send reminders of an upcoming event at a predetermined amount of time prior to a date of the upcoming event. For example, the system 100 may receive an input from the gifting user 5 that their mother's birthday is on January 2nd. The system 100 may create and store this event and event date, and at a predetermined amount of time prior to January 2nd, such as 2 weeks prior (on December 19th), the system 100 may send a reminder to the gifting user 5. The reminder may preferably be a notification to the electronic device 5a used by the gifting user 5, whether via the software application, text message, email, or the like.

Further, in some embodiments, there may not be an event date. For example, the gifting user 5 may simply want to send a gift to the at least one recipient user 15 for no particular reason. As such, the gifting user 5 would not input information pertaining to an event date, event theme, etc. Instead, the information provided by the gifting user 5 at this stage may be location of the at least one recipient user 15, type of gift contemplated, etc.; or alternatively, the gift request may not include gift criteria information 125. For example, the gifting user 5 may simply browse a plurality of potential gifts for inspiration.

A next step may include step 102 retrieving, via the server 110, the gift information 112 stored on the at least one database 120 on the server 110. As above, the gift request may include gift criteria information 125. As such, the server 110 may retrieve gift information 112 that is relevant to the gift criteria, such that the system 100 is able to provide tailored results for the gifting user 5 to choose from. For example, if the gifting user 5 input ‘birthday’ in the gift criteria, the server 110 may only retrieve gift information 112 pertaining to birthdays.

The gift information 112 may preferably include a plurality of potential gifts provided by a plurality of vendor users 10. For example, each product and/or service offering offered by each vendor user 10 (potential gifts) may contribute a portion of the gift information 112 stored on the at least one database 120. Further, the gift information 112 may also include information pertaining to the plurality of vendor users 10; for example, location, ratings, specialties, etc. The step 103 of displaying the gift information 112 to the gifting user 5 may then be next. Preferably, the plurality of gifts may be displayed as images, as demonstrated in FIG. 8. For example, the images may be photographs of particular goods or products; or may be promotional images such as posters, flyers, etc. Further, the system 100 may display further information about each of the plurality of potential gifts such as ingredients, taste, scent, descriptions, etc.

Again, as above, in some embodiments, the plurality of potential gifts/plurality of vendor users 10 shown may be determined by information received in the gift request (such as gift criteria information 125). For example, the plurality of gift vendor users 10 shown may be businesses that are local to the at least one recipient user 15. In another example, the plurality of vendor users 10 may be chosen based on an event theme. For example, if the event theme is “Valentine's Day,” local florists and bakeries may be chosen. In another example, if the event date is 2 days away from the date of the gift request, the plurality of potential gifts shown may be goods or services that are able to be created and delivered to the at least one recipient user 15 within that time frame.

The system 100 may allow the gifting user 5 to browse goods and/or services offered by each vendor before choosing the at least one vendor user 10. In some examples, the plurality of potential gifts may be shown under each vendor user 10 on one page for the gifting user 5 to quickly browse. In another example, the gifting user 5 may select a particular vendor user 10, taking them to a “vendor page” showing (causing the server 110 to display) a listing of each product/service offered by the particular vendor user 10.

In some embodiments, the system 100 may allow each of the plurality of vendor users 10 to link their social media accounts, allowing the gifting user 5 to browse the social media accounts of each vendor user 10. In addition to this, the system 100 may display customer reviews in relation to each vendor user 10, and in some embodiments, in relation to each potential gift offered by each of the vendor users 10. This may help the gifting user 5 decide on a particular vendor user 10 or a particular gift. In some embodiments, the plurality of vendor users 10 may be listed and ranked based on reviews. For example, a highest reviewed vendor user 10 may be at a top of the list.

In some embodiments, the gifting user 5 may already know a gift they would like to give. For example, the gifting user 5 may search for their at least one gift 118 on the system 100 (using their electronic device 5a to access the software application and/or website). For instance, the gifting user 5 may want to send flowers to the at least one recipient user 15, they may search “flowers” on the software application, and the server 110 may display florists local to the at least one recipient user 15 for the gifting user 5 to choose from.

The next step 104 may be receiving, at the server 110 at least one selection of at least one gift 118 from the gifting user 5. It should be appreciated that the gifting user 5 may choose more than one gift for the same at least one recipient user 15; or in some embodiments, the gifting user 5 may choose one or more gifts for one or more recipient users 15.

In some embodiments, once at least one gift 118 has been selected and received at the sever 110, the server 110 may allow the vendor users 10 that are able to create the at least one gift 118 to bid for the lowest price at which they can create the at least one gift 118. For example, upon receiving the at least one selection, the server 110 may send a bid request (after establishing specific vendors based on the at least one gift 118) to the specific vendors (via their electronic device 10a) that are able to create the at least one gift 118. The server 110 may receive bid proposals from the plurality of vendors 10 (or at least some of the plurality of vendors 10) and then may send the bid proposals to the gifting user 5. The gifting user 5 may then choose the vendor user 10 based on lowest bidder. Alternatively, the gifting user 5 may still have the option to choose whichever vendor user 10 they want to use, regardless of whether they are the lowest bidder or not.

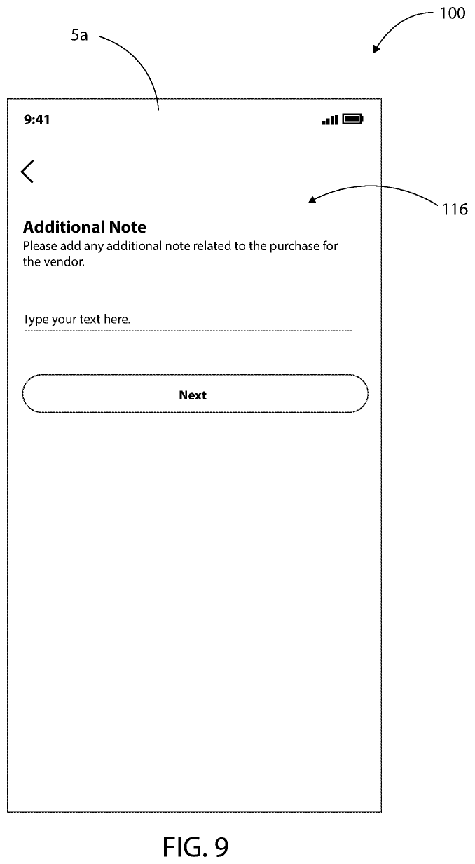

Once the at least one selection has been made (and the at least one vendor user 10 associated with the at least one gift 118 has been selected [“at least one chosen vendor user” 20]), the next step 105 may be displaying a data input form 116 to the gifting user 5, as demonstrated in FIG. 9. The data input form 116 may allow the gifting user 5 to input recipient information 114 to the system 100. It should be appreciated that the use of the word “form” is not meant to limit the data input form 116 to a particular configuration, style, etc. In some embodiments, the recipient information 114 may include at least one of recipient preference information, recipient address information, recipient location information and/or customization information for the at least one gift 118.

For example, recipient preference information may include allergies of the at least one recipient user 15, likes and dislikes of the at least one recipient user 15, etc. The recipient address information may include full mailing address of the at least one recipient user 15 or the full mailing address of a desired recipient location; the location information may include city, state, country of the recipient or city, state, country of the event, etc. Customization information for the at least one gift 118 may include particular customizations that the gifting user 5 and/or the at least one recipient user 15 would like to make to the at least one gift 118. For example, if the at least one gift 118 is a cake, the gifting user 5 and/or the at least one recipient user 15 may customize flavor of the cake. It should be appreciated that some of the recipient information 114 may have already been input at a previous step. For example, as discussed above, when the gifting user 5 (or any user) creates their profile, they may input information pertaining to their dietary restrictions, likes or dislikes, allergies, preferences, etc.

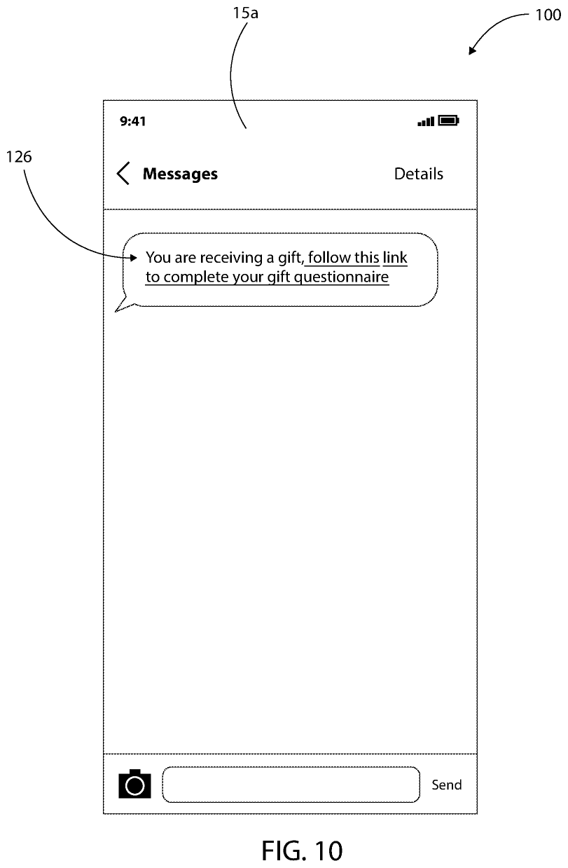

Further, in some embodiments, the computer implemented method 200 may include the step 104a of sending, via the server 110 an information input request 126 to the at least one recipient user 15. The information input request 126 may then be displayed to the at least one recipient user 15, as demonstrated in FIG. 10. Preferably, upon the at least one selection of the at least one gift 118, the gifting user 5 may be prompted (via the server 110) to provide the at least one recipient user's contact information, such as email or phone number. As such, the information input request 126 may be sent to the at least one recipient user 15 via email and/or text message and thus displayed on the electronic device 15a.

The information input request 126 may include a fillable questionnaire, survey, form, etc. for the at least one recipient user 15 to complete. For example, the fillable questionnaire may prompt information from the at least one recipient user 15 such as eating lifestyle, vegetarian, non-vegetarian, kosher, diabetic, halal; allergies; favorite food; etc. Preferably, the information input request 126 may be presented to the at least one recipient user 15 in such a way as to maintain at least a partial element of surprise. For instance, if the at least one gift 118 is a food product, the information input request 126 may question whether the at least one recipient user 15 possesses any allergies but may not provide any indication that the at least one gift 118 is a food product.

Again, alternatively, this information may be provided upon creation of a profile. For example, the at least one recipient user 15 (who may have signed up to be the gifting user 5 or may be prompted to sign up via the information input request 126) may set their own preferences and share them if desired. As such, the next step 106 may include receiving, at the server 110, recipient information 114 from at least one of the gifting user 5 and/or the at least one recipient user 15.

In some embodiments, the system 100 may be configured to take payment from the gifting user 5 for their purchase of the at least one gift 118. In doing so, in some embodiments, the system 100 may utilize a (secure) payment gateway 133 to process a transaction. As such, the computer implemented method 200 may include the step 106a of displaying the payment gateway 133 to the gifting user 5 (the payment gateway 133 allowing the gifting user 5 to input their payment information); and step 106b receiving payment information from the gifting user 5. Again, in some embodiments, the system 100 may already have the payment information. As such, the gifting user 5 may choose to utilize the payment information saved in the gifting user profile.

Using the system 100 to facilitate payment may provide assurance to the at least one chosen vendor user 20 that they will receive payment before creation and delivery of the at least one gift 118 and may provide assurance to the gifting user 5 that the at least one chosen vendor user 20 will create and deliver the at least one gift 118 after the payment. It should be appreciated that the system 100 may not always process the transaction and instead may simply facilitate connection between the gifting user 5 and at least one chosen vendor user 20. In some embodiments, the system 100 may include a messaging feature. In other embodiments, the server 110 may send only basic information between the gifting user 5 and the at least one chosen vendor user 20 (such as location).

The next step 107 may involve generating, via the server 110 at least one order request 117. Again, as above, the gifting user 5 may order more than one gift from more than chosen vendor user 20. As such, more than one order request 117 may be generated; and more than one order requests 117 may be sent to more than one chosen vendor users 20. The at least one order request 117 may include the at least one gift 118 (which gift(s) the gifting user 5 has selected) and the recipient information 114 (such as preference information, address, etc.)

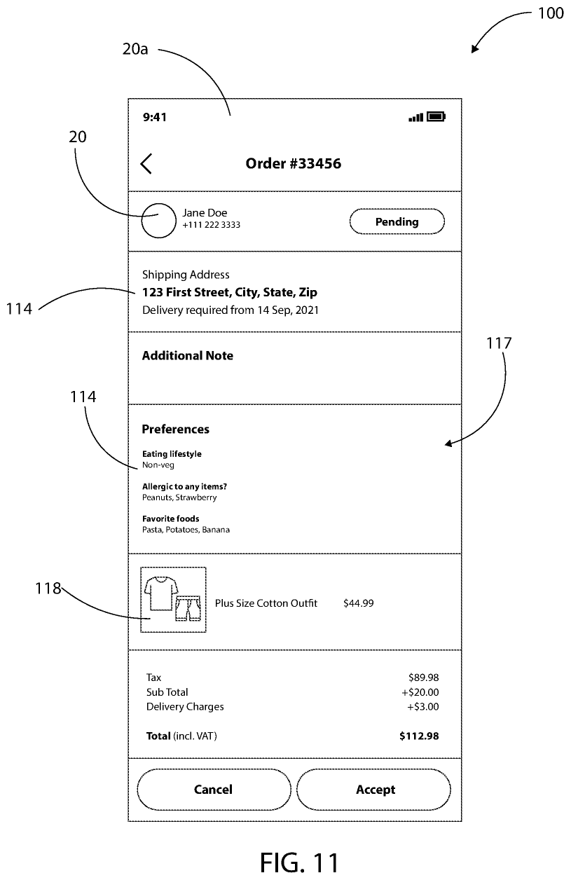

The next steps may include the step 108 of sending, via the server 110, the at least one order request 117 to the at least one chosen vendor user 20 and the step 109 of selectively displaying the at least one order request 117 to the at least one chosen vendor user 20. As shown in FIG. 11, the at least one order request 117 may display the recipient information 114 and the at least one gift 118 for the at least one chosen vendor user 20 to view on their electronic device 20a. Further, in some embodiments, the at least one chosen vendor user 10 may also be provided with other information such as the event information 132.

The at least one chosen vendor user 20 may create a final gift based on any customization, preferences, or the like, and arrange delivery of the final gift to the at least one recipient user 15 on the event date, or, in some embodiments, a different date specified by the gifting user 5 or the at least one recipient user 15 (for example, the at least one recipient user 15 may be able to select a delivery date during the customization step based on their schedule).

It should be noted that certain steps are optional step and may not be implemented in all cases. Optional steps of computer implemented method 200 are illustrated using dotted lines in FIG. 5 so as to distinguish them from the other steps of computer implemented method 200. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for gift giving are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A computer implemented method for gift giving, comprising:
receiving, at a server, a gift request from a gifting user;
retrieving, via the server, gift information stored on at least one database on the server, the gift information including a plurality of potential gifts provided by a plurality of vendor users;
displaying the gift information to the gifting user;
receiving, at the server, at least one selection of at least one gift from the gifting user;
displaying a data input form to the gifting user;
receiving, at the server, recipient information from at least one of the gifting user and at least one recipient user, the recipient information including at least recipient preference information;
generating, via the server, an at least one order request, the at least one order request including the at least one gift and the recipient information;
sending, via the server, the at least one order request to a at least one chosen vendor user, the at least one chosen vendor user being associated with the at least one gift; and
selectively displaying the at least one order request to the at least one chosen vendor user.

2. The computer implemented method of claim 1, further comprising the step of:
receiving, at the server, a gifting user profile request from the gifting user;
creating, via the server, a gifting user profile;
saving, via the server, the gifting user profile on the at least one database;
receiving, at the server, at least one of the recipient information, gifting user information and payment information; and
saving, via the server, the at least one of the recipient information, the gifting user information and the payment information to the gifting user profile on the at least one database.

3. The computer implemented method of claim 2, further comprising the step of:
receiving, at the server, a vendor user profile request from a vendor user;
creating, via the server, a vendor user profile;
saving, via the server, the vendor user profile on the at least one database;
receiving, at the server, a portion of the gift information, the portion of the gift information including at least one potential gift offered by the vendor user; and
saving, via the server, the portion of the gift information to the vendor user profile on the at least one database.

4. The computer implemented method of claim 3, wherein the gift request includes gift criteria information, and wherein the server retrieves gift information relevant to the gift criteria.

5. The computer implemented method of claim 4, wherein the plurality of potential gifts are displayed as images.

6. The computer implemented method of claim 1, further comprising the steps of:
sending, via the server, an information input request to the at least one recipient user; and
receiving, via the server, the recipient information from the at least one recipient user.

7. The computer implemented method of claim 6, wherein the recipient information further includes at least one of recipient address information, recipient location information and customization information for the at least one gift.

8. The computer implemented method of claim 1, further comprising the steps of:
receiving, at the server, event information from the gifting user; and
saving, via the server, the event information to the gifting user profile.

9. The computer implemented method of claim 1, further comprising the steps of:
displaying a payment gateway to the gifting user; and
receiving, at the server, the payment information from the gifting user.

10. A computer implemented method for gift giving, comprising:
receiving, at a server, a gift request from a gifting user, the gift request including gift criteria information;
receiving, at the server, event information from the gifting user;
saving, via the server, the event information to the gifting user profile;
retrieving, via the server, gift information stored on at least one database on the server, the gift information relevant to the gift criteria, the gift information including a plurality of potential gifts provided by a plurality of vendor users;
displaying the gift information to the gifting user, the plurality of potential gifts displayed as images;
receiving, at the server, at least one selection of at least one gift from the gifting user;
displaying a data input form to the gifting user;
sending, via the server, an information input request to a at least one recipient user;
receiving, at the server, recipient information from at least one of the gifting user and the at least one recipient user, the recipient information including at least one of recipient preference information, recipient address information, recipient location information and customization information for the at least one gift;
displaying a payment gateway to the gifting user;
receiving payment information from the gifting user;
generating, via the server, an at least one order request, the at least one order request including the at least one gift and the recipient information;
sending, via the server, the at least one order request to at least one chosen vendor user from the plurality of vendor users, the at least one chosen vendor user being associated with the at least one gift; and
selectively displaying the at least one order request to the at least one chosen vendor user.

11. The computer implemented method of claim 10, further comprising the steps of:
receiving, at the server, a gifting user profile request from the gifting user;
creating, via the server, a gifting user profile;
saving, via the server, the gifting user profile on at least one database on the server;
receiving, at the server, at least one of recipient information and gifting user information;
saving, via the server, the at least one of the recipient information and the gifting user information to the gifting user profile on the at least one database;
receiving, at the server, a vendor user profile request from a vendor user;
creating, via the server, a vendor user profile;
saving, via the server, the vendor user profile on the at least one database;
receiving, at the server, a portion of gift information, the portion of the gift information including at least one potential gift offered by the vendor user;
saving, via the server, the portion of the gift information to the vendor user profile on the at least one database.

12. A system for gift giving, comprising:
at least one server including at least one database and at least one processor, the at least one server storing computer executable instructions that when executed cause the at least one processor to:
receive a gift request from a gifting user;
retrieve gift information stored on at least one database on the server, the gift information including a plurality of potential gifts provided by a plurality of vendor users;
display the gift information to the gifting user;
receive at least one selection of at least one gift from the gifting user;
display a data input form to the gifting user;
receive recipient information from at least one of the gifting user and a at least one recipient user, the recipient information including at least recipient preference information;
generate an at least one order request, the at least one order request including the at least one gift and the recipient information;
send the at least one order request to a at least one chosen vendor user, the at least one chosen vendor user being associated with the at least one gift; and
selectively display the at least one order request to the at least one chosen vendor user.

13. The system of claim 12, wherein the at least one processor is further configured to:
receive a gifting user profile request from the gifting user;
create a gifting user profile;
save the gifting user profile on the at least one database;
receive at least one of the recipient information, gifting user information and payment information; and
save the at least one of the recipient information, the gifting user information and the payment information to the gifting user profile on the at least one database.

14. The system of claim 13, wherein the at least one processor is further configured to:
receive a vendor user profile request from a vendor user;
create a vendor user profile;
save the vendor user profile on the at least one database;
receive a portion of the gift information, the portion of the gift information including at least one potential gift offered by the vendor user; and
save the portion of the gift information to the vendor user profile on the at least one database.

15. The system of claim 14, wherein the gift inquiry includes gift criteria information, and wherein the server retrieves gift information relevant to the gift criteria.

16. The system of claim 15, wherein the plurality of potential gifts are displayed as images.

17. The system of claim 12, wherein the at least one processor is further configured to:
send an information input request to the at least one recipient user; and
receive the recipient information from the at least one recipient user.

18. The system of claim 16, wherein the recipient information further includes at least one of recipient address information, recipient location information and customization information for the at least one gift.

19. The system of claim 12, wherein the at least one processor is further configured to:
receive event information from the gifting user; and
save the event information to the gifting user profile.

20. The system of claim 12, wherein the at least one processor is further configured to:
display payment gateway to the gifting user; and
receive the payment information from the gifting user.
